(19) United States
(12) Patent Application Publication
(10) Pub. No.: US 2020/0194172 A1
(43) Pub. Date: Jun. 18, 2020

(54) Reactor and Respective Manufacturing Method

(71) Applicant: ABB Schweiz AG, Baden (CH)

(72) Inventors: Andrea Cremasco, Pavia (IT); Paolo Canavesi, Montano Lucino (IT)

(73) Assignee: ABB Schweiz AG, Baden (CH)

(21) Appl. No.: 16/641,542

(22) PCT Filed: Aug. 23, 2018
(86) PCT No.: PCT/EP2018/072715

§ 371 Date: Feb. 24, 2020

(30) Foreign Application Priority Data
Aug. 24, 2017 (EP) 17187686.5

(51) Int. Cl. H01F 41/12; H02K 15/12; H01F 41/063

(52) U.S. Cl. CPC H01F 41/127; H01F 41/063; H02K 15/12

(57) ABSTRACT

A method for producing a reactor with at least one winding section for power applications is provided. The method comprises providing a tank; winding at least one conducting layer about a cylindrical support mold, and at least partially embedding the at least one conducting layer in a fibrous material, to produce a winding section; placing the winding section in the tank, applying a vacuum to the tank; impregnating the winding section in the tank with a resin, while applying a pressure to the tank.

### FIELD OF THE INVENTION

The subject matter described herein relates generally to reactors for medium and high voltage power applications, and more particularly to reactors with winding sections produced using vacuum pressure impregnation.

### TECHNICAL BACKGROUND

Reactors are, as transformers, magnetic components used in various electrical applications. Air-Core Reactors (ACR) or inductors provide a linear response of their impedance versus current. This is essential for numerous applications, e.g. filtering, shunting, damping, etc., and for different types of installations like utility substations, distribution banks, wind farms, rectifier loads in electro-winning and electrochemical processes, large drives, cyclo-converters, steelmaking electric arc furnaces, mines or smelters or cement plants, and generally industrial applications.

The main target of reactor applications of utilities is to optimize the power flow in the transmission and sub-transmission grids, and to avoid situations that might be critical for the equipment or for the stability of the power system. Current limitation can also be an issue in distribution grids, and may become of higher relevance due to the installation of additional distributed power generation systems like wind turbines, photovoltaic power generation systems, small hydro power stations, biomass, etc. Other types of applications address specific industrial applications, having typically high power consumption and using processes that create harmonics or high reactive power. Such installations may also be located at rather weak grids. The installations can be owned and operated either by the industry itself or by the utility.

Almost throughout the industry, manufacturers of such reactors produce the winding sections of reactors by using the well-known ‘wet winding technology’. This includes the use of glass filament material such as mats, which is or are pre-impregnated with an epoxy resin, which is known as prepreg-material. These materials are applied to the winding sections, and the included curable resin is subsequently cured in order to produce encapsulated winding sections.

The above described, conventional techniques leave room for improvement. Hence, there is a need for the present invention.

### SUMMARY OF THE INVENTION

These objectives are achieved by the invention as claimed in the independent claims. The dependent claims and claim combinations contain various embodiments thereof. According to a first aspect, a method for producing a reactor with at least one winding section for power applications is provided. The method comprises providing a tank; winding at least one conducting layer about a cylindrical support mold, and at least partially embedding the at least one conducting layer in a fibrous material, to produce a winding section; placing the winding section in the tank, applying a vacuum to the tank; impregnating the winding section in the tank with a resin, while applying a pressure to the tank. This, in particular, includes the step of immersing the winding section in a curable resin. Further in particular, the method can comprise the step of: removing the winding section from the tank and leaving the resin to cure, preferably to cure in an oven.

According to a second aspect, a reactor produced by a method according to the first aspect is provided.

According to a third aspect, a use of a vacuum impregnation process in manufacturing at least one winding section of an electrical power reactor is provided.

Further aspects, advantages and features of the present invention are apparent from the dependent claims, claim combinations, the description and the accompanying drawings.

### BRIEF DESCRIPTION OF THE DRAWINGS

A full and enabling disclosure, including the best mode thereof, to one of ordinary skill in the art, is set forth more particularly in the remainder of the specification, including reference to the accompanying figures wherein:

FIG. 1 shows a power reactor produced with a method according to embodiments, with a section removed for illustrational purposes;

FIG. 2 schematically shows a cross-sectional view through a winding section of a power reactor during its production according to embodiments;

FIG. 3 schematically shows a cross-sectional view through a winding arrangement of a power reactor, during its production according to embodiments;

FIG. 4 shows how a winding arrangement is placed into a tank during its production according to embodiments;

FIG. 5 shows a vacuum being applied to the winding arrangement in the tank of FIG. 4, according to embodiments;

FIG. 6 shows the tank partially filled with a curable resin, while a pressure is applied to the tank for a vacuum pressure impregnation.

### GENERAL ASPECTS OF THE INVENTION

According to an aspect, a method includes providing an end wrapping comprising a fibrous material around at least one axial end of at least one winding section.

According to an aspect, at least two winding sections are produced, which have different inner and outer diameters with respect to each other, wherein the diameters are configured such that a cooling channel/cooling duct is formed between the winding sections.

According to an aspect, the at least two winding sections are electrically connected in parallel at each of the axial ends of the winding sections. The step of electrically connecting may include: providing a first terminal at a first axial end of the winding sections, and providing a second terminal at a second axial end of the winding sections.

According to an aspect, at least one of the first terminal and the second terminal includes a plurality of elongated elements extending radially from a center portion towards the winding sections. The elements are preferably equally distributed angularly in a circumferential direction of the reactor.

According to an aspect, the first terminal and second terminal and their connection to the winding sections are configured to provide mechanical stability to the reactor.

According to an aspect, the innermost winding part of the reactor encloses a substantially cylindrical air volume.

According to an aspect, distance elements are provided in at least one cooling channel between at least the first winding section and the second winding section.

According to aspects, the cross-sections and/or the composition of the conductors and/or the number of winding turns and/or winding layers of the coil may vary between winding sections; and/or wherein each layer comprises a plurality of turns axially arranged along the winding axis, and/or wherein each turn comprises one or more conductors axially and radially arranged.

According to an aspect, at least one winding section includes an insulation material between consecutive winding layers of the coil in the respective winding section.

According to an aspect, at least one winding section includes an insulating tape on its outer surface, which is applied prior to an impregnation.

According to an aspect, elongated insulators are mounted to at least one axial end of the reactor.

According to an aspect, a fibrous material comprises a felt mat or woven fibrous material, which in a non-limiting example comprises glass or polyester-glass.

According to aspects, a reactor manufactured according to any of the previous aspects is provided.

According to an aspect, the use of a vacuum pressure impregnation process in manufacturing at least one winding section of an electrical power reactor is provided. The process may be used for two winding sections having different inner and outer diameters, such that the winding sections are concentrically stackable.

According to aspects, a method for producing winding sections of a reactor for power applications is provided. For producing a winding section, a plurality of components including the conductor is arranged, while at least some of the materials are subject to an impregnation process and/or to a coating process. The encapsulation of the winding section is configured to be weatherproof, to have very little maintenance requirements and is further configured to fulfil requirements with respect to UV resistance. Further, the encapsulation is configured to have resistance to chemical and physical degradation by water, ice, conductive or dielectric dust, etc. according to specific pollution classes.

A general aspect is to seal completely, respectively to encapsulate, the conductor(s) of the winding section(s) by wrapping the conductor with impregnable materials and to subsequently impregnate the wrapped conductor with a curable resin. To this end, a vacuum impregnation process, more typically a vacuum pressure impregnation (VPI) process, is applied. After the impregnation, a tape may be applied to further protect and insulate the winding section from the environment. A final coating with a UV resistant paint may then be applied for enhanced UV protection and tracking erosion resistance.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

Although specific features of various embodiments of the invention may be shown in some drawings and not in others, this is for convenience only. In accordance with the principles of the invention, any feature of a drawing may be referenced and/or claimed in combination with any feature of any other drawing.

Within the following description of the drawings, the same reference numbers refer to the same components. Generally, only the differences with respect to the individual embodiments are described.

As used herein, the term “fibrous material” is intended to include dielectric materials which comprise fibers. In particular, fibrous material includes felt mats or woven fibrous material. Typical, but non-limiting examples for materials are glass/silica felt mats, woven glass, or polyester-glass tape.

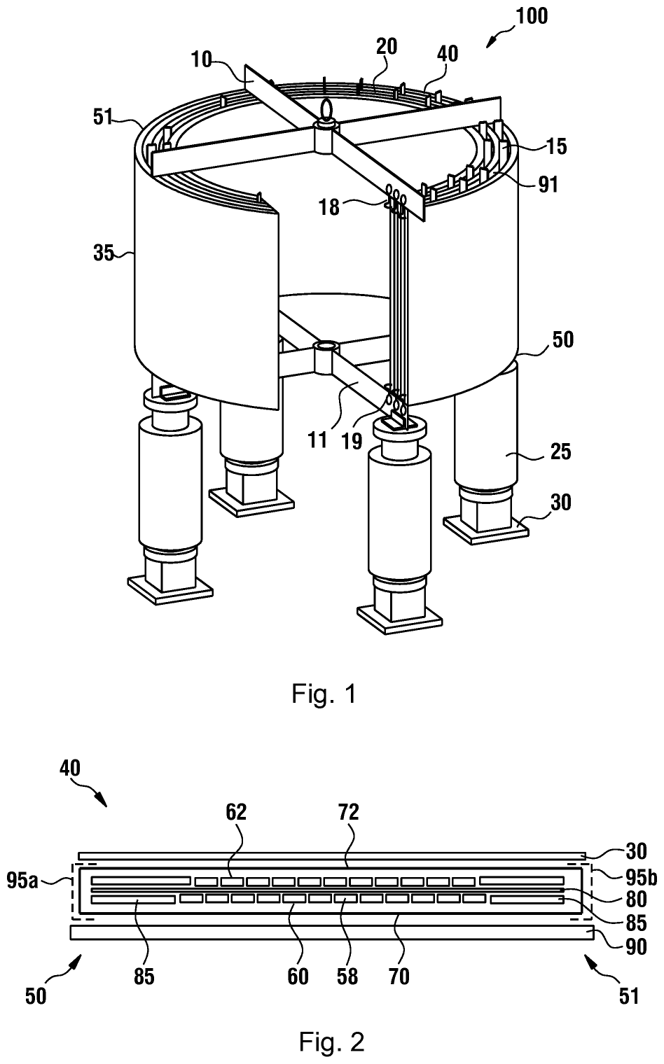

In FIG. 1, a reactor 100 for power applications is shown, which was produced with a method according to embodiments described herein. It comprises a winding arrangement 35 which typically comprises at least two winding sections 40 which typically have different inner and outer diameters and are concentrically arranged. Between the winding sections 40, cooling channels or ducts 91 are typically, but not necessarily provided. The defined distances between the concentric winding sections 40 are maintained by a plurality of placeholders 15 which are radially distributed in each cooling channel 91 between the winding sections 40 (note that in FIG. 1, the placeholders 15 are not evenly distributed radially for illustrational purposes only). At the first axial end 50, which is typically the bottom end of the reactor 100 and of the winding sections 40, and at the second axial end 51, typically the top end of each of the winding sections 40, electrical terminals are provided to electrically connect the at least two winding sections 40 in parallel. As is shown, the terminals 10, 11 which connect the winding sections 40 have, in the non-limiting example shown, basically the shape of a cross. The upper terminal 10 and lower terminal 11 also serve for providing mechanical stability to the winding arrangement 35. As the reactor 100 has no stabilizing solid core (i.e. iron core) provided on the inside of the winding arrangement 35, but has typically an air core, this is usually required to maintain the mechanical stability of the reactor 100. A plurality of bottom insulators 25, for example 1 to 4 bottom insulators, are mounted to the lower terminal 11 and are typically ending in a pedestal 30 each. At a first connection portion 19, the winding sections 40 (three in the non-limiting example of FIG. 1) are connected in parallel to the lower terminal 11, and at second connection portion 18, the winding sections are connected in parallel to the upper terminal 19.

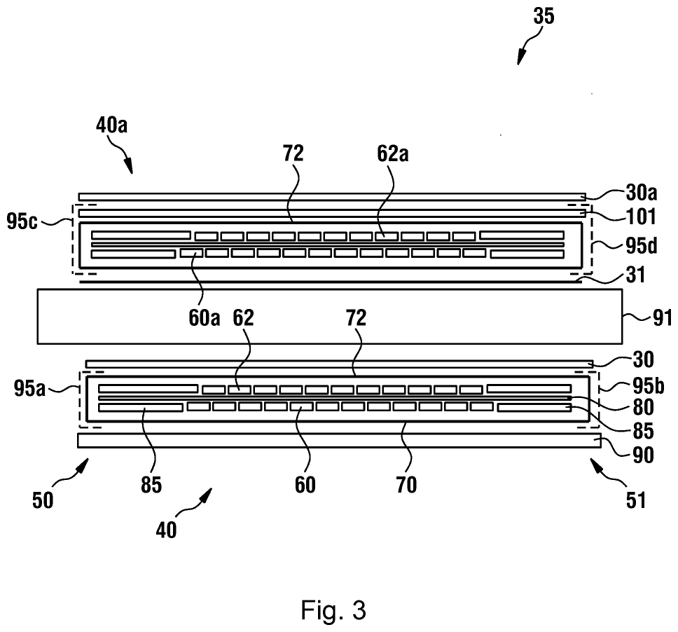

In FIG. 2, a cross-sectional view through a winding section 40 of the reactor 100 of FIG. 1 according to embodiments is shown. The winding section 40 forms a part of the winding arrangement 35 of FIG. 1. The winding arrangement may include one winding section 40, or typically more than one winding section 40. The winding section 40 of FIG. 2 is produced with a method according to embodiments. In embodiments, further winding sections 40a (not shown in FIG. 2, see FIG. 3) may be added having a greater radius, which are typically separated from the innermost winding section 40 by radial cooling ducts 45. For the production of the winding section 40 as shown, first a cylindrical support mold 90 is provided. This support mold 90 typically serves as the basis, or differently expressed, as a carrier, for the production of the one or more winding section(s) 40 ofthe reactor 100. Thereby, if present, the more than one winding sections 40 together form the winding arrangement 35 of the reactor 100 (see FIG. 1). For producing the winding section 40 of FIG. 2, at least one conductor 58 is wound in a first conductor layer 60 about the support mold 90, and is thereby axially arranged about at least a part of the axial length of support mold 90. In order to encapsulate the first conductor layer 60, fibrous material is provided surrounding the first conductor layer 60, which is described further below. The fibrous material is subsequently impregnated with a resin, as is described further below. The encapsulation serves, for example, the purpose of electrically insulating the first conductor layer 60 and to protect it from an undesired influence of the surroundings like moisture, rain, or dust. In FIG. 2, a non-limiting example of an arrangement of a conductor and elements of a fibrous material are shown, according to embodiments. A first dielectric layer 70 comprising a felt mat, which typically comprises a fibrous material such as glass fiber, is provided between the first conductor layer 60 and the support mold 90. In order to produce the winding section 40 like this, the felt mat 70 is provided around the support mold 90, prior to the conductor 58 being wound about the support mold 90. Further, a coil end wrapping 95a, 95b is provided on both axial ends 50, 51 of the winding section, respectively, of the support mold 90. As the coil end wrapping 95a, 95b is partially provided to be closer to the support mold 90 than the first conductor layer 70, the material for the coil end wrapping 95a, 95b is provided to the support mold 90 as the first step in the production process of the winding section 40, just after providing the support mold 90 itself. After both the coil end wrapping 95a, 95b at both axial ends 50, 51 of the support mold 90 and the first dielectric layer 70 are provided to the support mold 90, the first conductor layer 60 is wound about the support mold 90. Optionally, as shown, there may be added a second conductor layer 62, after applying an interlayer insulation 80 on the completed first conductor layer 60. An end filling 85 may be provided at the axial ends of the first conductor layer 60. The end filling 85 may, for example, comprise felt mat. Typically, after applying the first conductor layer 60 and the interlayer insulation 80, the first dielectric layer 70 and the coil end wrapping 95a, 95b are wrapped also around the second conductor layer 62 at the axial ends 50, 51. A further felt mat is then added on the outside of this wrapped-up compound as an outermost insulation 72 of the winding section 40. A tape 30, which may for example be a conventional glass tape, is finally wrapped about the outermost insulation 72. Up to this stage, the various components are typically not impregnated with a resin. In order to encapsulate the winding section 40, the just produced compound shown in FIG. 2 will, according to embodiments, subsequently undergo a vacuum pressure impregnation (VPI) process. Typically, however, the winding arrangement 35 of a reactor 100 according to embodiments, such as shown in FIG. 1, comprises at least two winding sections 40, such as the one described with respect to FIG. 2, which have different inner and outer diameters and are provided in a coaxial manner.

In FIG. 3, it is shown how the winding section 40 of FIG. 2 may be further modified to achieve a winding arrangement 35 with two or more winding sections 40, 40a, according to embodiments. On the tape 30, being the outermost layer of the winding section 40 of FIG. 2, a cooling duct 91 is provided, which runs radially around the cylindrical winding section 40. In order to achieve the cooling duct 91, a number of placeholders 15 (not shown, see FIG. 1) are disposed about the winding section 40 of FIG. 2. They each typically protrude in an axial direction from the first axial end 50 of the winding section to the second axial end 51.

Further, in FIG. 3, a winding arrangement 35 with two winding sections 40, 40a, such as shown in FIG. 2, is depicted. Differently from the production of the winding section 40 described with respect to FIG. 2, firstly, a tape 31 is provided around the placeholders 15 for the cooling duct 91. The provision of the conductor layers 60a, 62a, the coil end wrapping 95c, 95d and the interlayer insulation (analogous to interlayer insulation 80) is largely similar to the procedure shown with respect to FIG. 2. Additionally, for an outermost winding section 40a, such as is the case with the upper winding section 40a in FIG. 3, a further dielectric layer is added. That is, a further mat of fibrous material, for example a felt mat of glass fiber, is provided as an outer insulation 101 in the example of FIG. 3. Analogous to the example of FIG. 2, a tape 30a, which may for example be a conventional glass tape, is finally wrapped about the outer insulation 101.

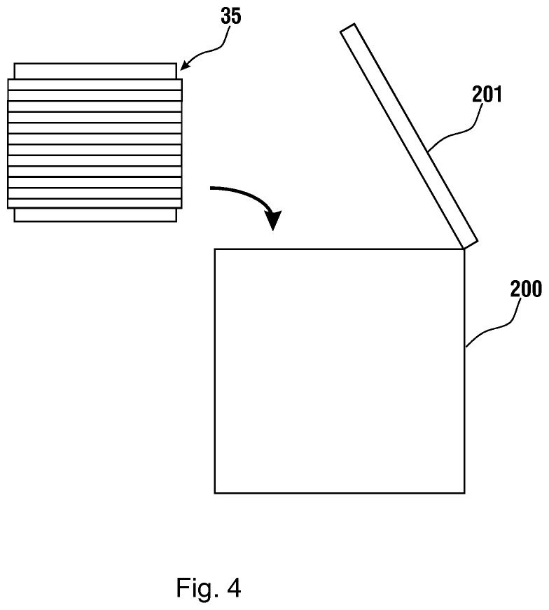

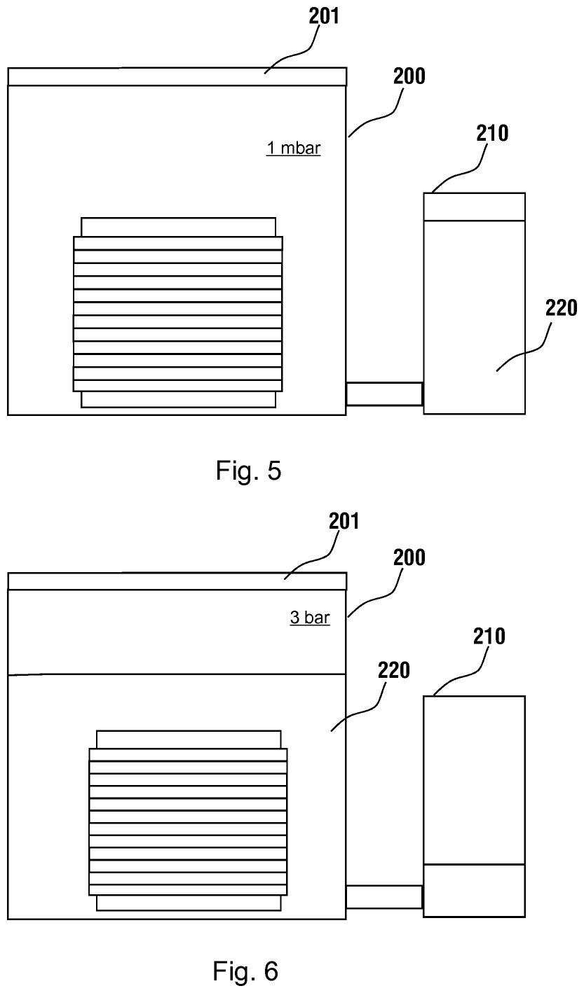

It is noted that the winding arrangement shown in FIG. 3 comprises various dielectric elements and conductor layers, but is still not impregnated with a resin. A sufficient mechanical stability of the winding arrangement 35 of FIG. 3 is achieved due to the conductors of the layers 60, 62 being wound with a mechanical tension in order to provide stability to the winding arrangement of FIG. 3. After the winding arrangement has been produced with the conductor layers and the dielectric materials provided as described with respect to FIG. 2 and FIG. 3, the winding arrangement undergoes a vacuum pressure impregnation (VPI). For VPI, the winding arrangement 35 is placed into a hermetically sealable tank 200 with a movable cap 201, see FIG. 4. In FIG. 4 to FIG. 6, the winding arrangement is simplified for illustrational purposes, and the indicated pressure values in FIG. 5 and FIG. 6 are only exemplary and non-limiting. For example, the terminals 10, 11 are typically mounted to the winding arrangement 35 previously to being inserted into tank 200, but are not shown in FIGS. 4 to 6 for illustrational purposes. In FIG. 5, it is schematically shown that, via an integrated pump system, the pressure in the tank 200 of the VPI apparatus is first reduced to vacuum. In practice, the pressure may be in the range from well below 0.1 mbar up to 10 mbar, for example from 0.01 mbar to 10 mbar, or from 0.05 mbar to 5 mbar. During this step, gases from within the felt mats of the winding section/winding arrangement, and in between the windings of the conductors, etc. are typically nearly entirely removed by the application of the vacuum. It is understood that generally, the lower the pressure, the better is the rate of removal of residual gas, which leads to an improvement of the quality of the subsequent pressure impregnation.

As is further schematically shown in FIG. 6, the winding arrangement is then completely immersed in a curable resin 220. The resin 220 is typically epoxy resin, or may also be polyester resin or similar. The pressure applied to the resin-filled tank 200 may be, for example, in the range from 2 bar to 8 bar, more typically from 2.5 bar to 7 bar, more preferred in a range from 3 bar to 6 bar, for example 3 bar, 4 bar, 5 bar, or 6 bar. As in the previous step, nearly all gas residues are removed from the material compound of the winding arrangement, the pressure causes the resin 220 to penetrate also very small spaces in the materials of the compound. After the compound has been treated with the VPI method as described, the impregnated winding arrangement 35 is removed from the tank 200 and the resin is left to cure. When the resin is completely cured, the winding arrangement 35, as was described with respect to FIG. 1, is completely produced.

After the winding arrangement 35 is produced as described with respect to FIG. 4 to FIG. 6, it is mounted with the elements as were described with respect to FIG. 1. Thus, terminals 10, 11, which connect the winding sections 40, are mounted at both axial ends 50, 51 of the winding arrangement 40. A plurality of bottom insulators 25, for example 1 to 4, are mounted to the lower terminal 11 and may typically be mounted to a pedestal 30 each.

A reactor for power applications produced according to embodiments provides a higher level of impregnation compared to conventional techniques such as prepreg or wet winding. Consequently, in outdoor applications, moisture/water absorption is reduced. The compound structure of the winding arrangement is optimized for the VPI method, which together achieves a better encapsulation, which is advantageous in case of outdoor applications of reactors according to embodiments.

The final reactor produced according to the present invention is a stand-alone device. It may contain, but need no contain an epoxy tube or an epoxy-glass-composite tube inside the winding sections 40, 40a. It has an air core, thus is devoid of an iron core.

Exemplary embodiments of systems and methods for producing a reactor are described above in detail. The systems and methods are not limited to the specific embodiments described herein, but rather, components of the systems and/or steps of the methods may be utilized independently and separately from other components and/or steps described herein, and are not limited to practice with only a reactor as described herein. Rather, the exemplary embodiments can be implemented and utilized in connection with many other applications.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-20. (canceled)

21. Method for producing a reactor with at least two winding sections for power applications, the method comprising:
providing a tank;
winding at least one conducting layer about a cylindrical support mold, and at least partially embedding the at least one conducting layer in a fibrous material, to produce at least two winding sections and to form a coil, wherein at least two of the winding sections are concentrically provided on the cylindrical support mold and have different inner and outer diameters with respect to each other;
placing the winding sections in the tank,
applying a vacuum to the tank;
immersing the winding sections in a curable resin;
impregnating the winding sections in the tank with the resin, while applying a pressure in the range from 2 bar to 8 bar to the tank;
removing the winding sections from the tank; and
leaving the resin to cure.

22. The method of claim 21, further comprising: providing an end wrapping comprising a fibrous material around at least one axial end of the winding section.

23. The method of claim 21, wherein the diameters of the winding sections are configured such that a cooling duct is formed between the winding sections; and electrically connecting the at least two winding sections in parallel at each of the axial ends of the winding sections.

24. The method according to claim 23, wherein electrically connecting comprises providing a first terminal at a first axial end of the winding sections, and providing a second terminal at a second axial end of the winding sections.

25. The method of claim 24, wherein at least one of the first terminal and the second terminal comprises a plurality of elongated elements extending radially from a center portion towards the winding sections, and wherein the elements are preferably equally distributed angularly in a circumferential direction of the reactor.

26. The method of claim 25, wherein the first terminal and second terminal and their connection to the winding sections are configured to provide mechanical stability to the reactor; at least one of the terminals having the shape of a cross, for providing the mechanical stability to the winding section of the reactor.

27. The method according to claim 23, further comprising: providing placeholders in the cooling duct between a first winding section and a second winding section.

28. The method of claim 21, wherein at least one of the cross-sections, the composition of the conductors, the number of winding turns or the wound conducting layers of the coil may vary between the winding sections (40, 40a).

29. The method of claim 21, wherein the winding sections comprise an interlayer insulation between consecutive winding layers in the respective winding section.

30. The method of claim 21, wherein at least one of the winding sections comprises a tape on their outer surfaces, which is applied prior to the impregnation.

31. The method of claim 22, wherein the fibrous material comprises a felt mat or woven fibrous material.

32. The method of claim 21, wherein a coating is applied to an outermost surface of the reactor, which is preferably a UV resistant coating.

33. The method of claim 21, wherein the winding section is completely immersed in the curable resin, wherein the resin is epoxy resin or polyester resin.

34. The method of claim 21, wherein the pressure applied to the resin-filled tank is in the range from 2.5 bar to 7 bar.

35. An air-core reactor, manufactured according to the method of claim 21.

36. Use of a vacuum pressure impregnation process according to the method of claim 21 in manufacturing at least two winding sections of an electrical power reactor.

37. The method of claim 25, wherein the first terminal and second terminal and their connection to the winding sections are configured to provide mechanical stability to the reactor; both terminals each having the shape of a cross, for providing the mechanical stability to the winding section of the reactor.

38. The method of claim 21, wherein each conducting layer comprises a plurality of turns axially arranged along the winding axis.

39. The method of claim 21, wherein each turn comprises one or more conductors axially and radially arranged.

40. The method of claim 21, wherein the pressure applied to the resin-filled tank is in a range from 3 bar to 6 bar.
